(19) United States
(12) Patent Application Publication
(10) Pub. No.: US 2008/0198412 A1
(43) Pub. Date: Aug. 21, 2008

(54) Data processing device and data processing method

(75) Inventor: Akihiro Yamada, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/071,323

(22) Filed: Feb. 20, 2008

(30) Foreign Application Priority Data
Feb. 20, 2007 (JP) 2007-039436

(51) Int. Cl. G06F 15/00

(52) U.S. Cl. 358/1.16; 358/1.15; 358/1.1

(57) ABSTRACT

There is provided a data processing device having a plurality of functions including at least a print function of forming an image on a recording medium and a facsimile function of transmitting facsimile data. The data processing device comprises: a connection unit to which a portable storage medium is detachably attached; a storage unit configured to store relationship information defining relationship between a data type and a function to be executed for data having the data type; a reading unit configured to read data from the portable storage medium attached to the connection unit; a judgment unit configured to judge a data type of the data read by the reading unit from the portable storage medium; and a function execution unit configured to execute one of the plurality of functions corresponding to the data type judged by the judgment unit.

### CROSS-REFERENCE TO RELATED APPLICATION

This application claims priority under 35 U.S.C. §119 from Japanese Patent Application No. 2007-039436, filed on Feb. 20, 2007. The entire subject matter of the application is incorporated herein by reference.

### BACKGROUND

1. Technical Field

Aspects of the present invention relate to a data processing device having a print function of forming an image on a recording sheet and a facsimile function of transmitting and receiving facsimile data via a telephone network, and particularly to processing of data stored in a portable storage medium with one of the print and facsimile functions.

2. Related Art

Data processing devices having a print function of forming an image on a recording sheet and a facsimile function of transmitting and receiving facsimile data via a telephone network have been widely used. Since such a data processing device has a plurality of functions, it is frequently called a multifunction peripheral. In general, the data processing device is configured such that a user selects and executes a desired function through an operation panel provided on the data processing device each time data is to be processed through the data processing device.

Japanese Patent Provisional Publication No. 2000-298721 (hereafter, referred to as JP2000-298721A) discloses a data processing device capable of processing data stored in a portable storage medium, such as a USB memory and a memory card. In JP2000-298721A, it is described that a particular file name is assigned to data stored in a portable storage medium so that a process corresponding to the file name of the data can be automatically executed on the data processing device.

However, the data processing device disclosed in JP2000-298721A has a drawback that it is required to assign a particular file name to data to be processed. Such a configuration can cause inconvenience that, in a situation where a user operates a personal computer and the data processing device repeatedly to edit data on the personal computer and to process the edited data on the data processing device while using a portable storage medium to exchange the data between the personal computer and the data processing device, the user can not assign a desired file name to the data stored on the portable storage medium.

### SUMMARY

Aspects of the present invention are advantageous in that at least one of a data processing method and a data processing device having at least a print function and a facsimile function configured to automatically process data stored in a portable storage medium in a situation where a user can assign desired file name to data stored in the portable storage medium is provided.

According to an aspect of the invention, there is provided a data processing device having a plurality of functions including at least a print function of forming an image on a recording medium and a facsimile function of transmitting facsimile data. The data processing device comprises: a connection unit to which a portable storage medium is detachably attached; a storage unit configured to store relationship information defining relationship between a data type and a function to be executed for data having the data type; a reading unit configured to read data from the portable storage medium attached to the connection unit; a judgment unit configured to judge a data type of the data read by the reading unit from the portable storage medium; and a function execution unit configured to execute one of the plurality of functions corresponding to the data type judged by the judgment unit.

With this configuration, even if data is stored in a portable storage medium on a device (e.g., a personal computer) under a file name assigned freely, it is possible to automatically execute a desired function for the file stored in the portable storage medium.

According to another aspect of the invention, there is provided a method of processing data on a data processing device having a plurality of functions including at least a print function of forming an image on a recording medium and a facsimile function of transmitting facsimile data. The method comprising the steps of: reading data from a portable storage medium attached to the data processing device; judging a data type of the data read from the portable storage medium; and executing one of the plurality of functions corresponding to the data type in accordance with relationship information defining relationship between each data type and a corresponding function to be executed.

With this configuration, even if data is stored in a portable storage medium on a device (e.g., a personal computer) under a file name assigned freely, it is possible to automatically execute a desired function for the file stored in the portable storage medium.

According to another aspect of the invention, there is provided a method of processing data on a data processing device having a plurality of functions including at least a print function of forming an image on a recording medium and a facsimile function of transmitting facsimile data. The method comprising the steps of: reading data from a portable storage medium attached to the data processing device in accordance with priority information defining priority for processing a plurality of data types; and executing one of the plurality of functions corresponding to a data type of the data read from the portable storage medium in accordance with relationship information defining relationship between each data type and a corresponding function to be executed.

With this configuration, even if data is stored in a portable storage medium on a device (e.g., a personal computer) under a file name assigned freely, it is possible to automatically execute a desired function for the file stored in the portable storage medium.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a perspective view of a MFP (Multifunction Peripheral) according to an embodiment.

FIG. 2 is a perspective view of the MFP illustrating a state where a body cover is opened with respect to a main body.

FIG. 3 illustrates an internal structure of the main body of the MFP.

FIG. 4 is a cross sectional view illustrating an internal structure of the body cover and a reading unit of the MFP.

FIG. 5 is a block diagram of a control system of the MFP.

FIG. 6 is an explanatory illustration for explaining a hierarchical menu structure of items used to set automatic execution of functions of the MFP.

FIG. 7 illustrates an example of a function management table stored in the MFP.

FIG. 8 is a flowchart illustrating a process for automatically executing a function for a file in a USB memory.

### DETAILED DESCRIPTION

Hereafter, an embodiment according to the invention will be described with reference to the accompanying drawings.

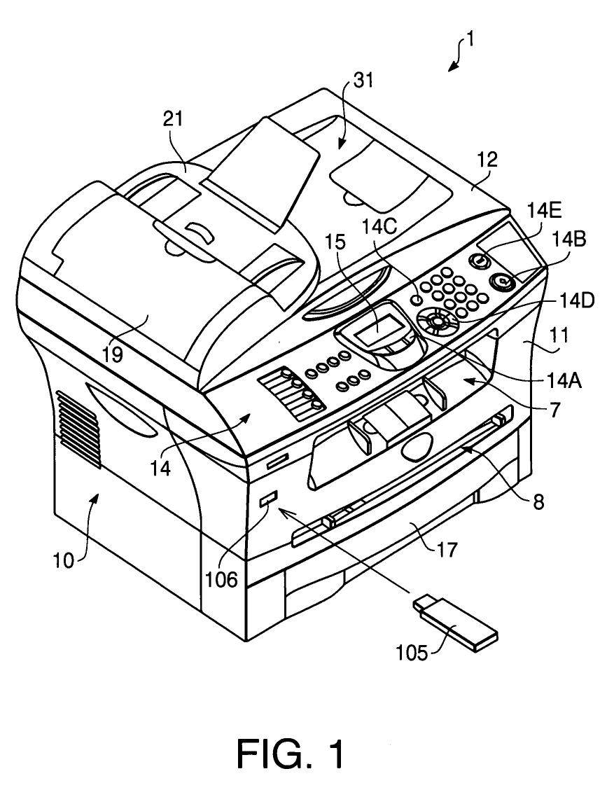

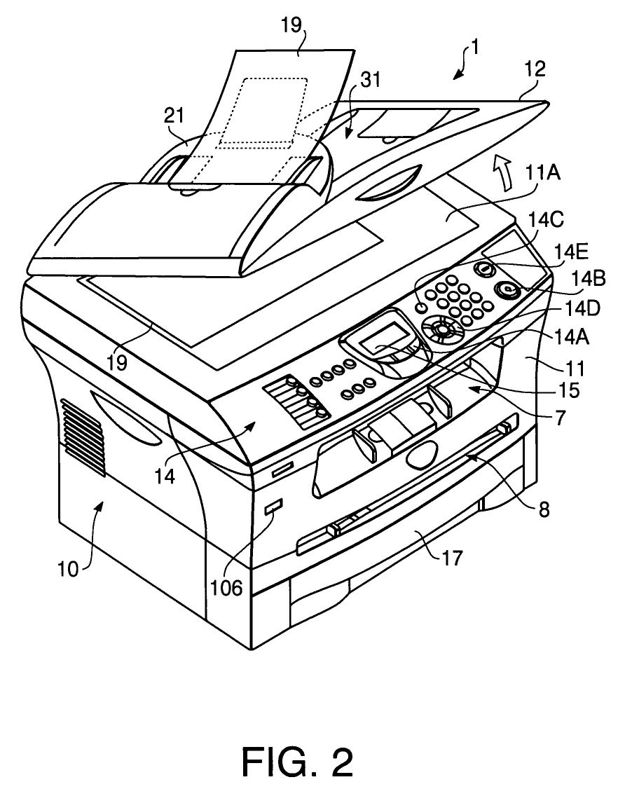

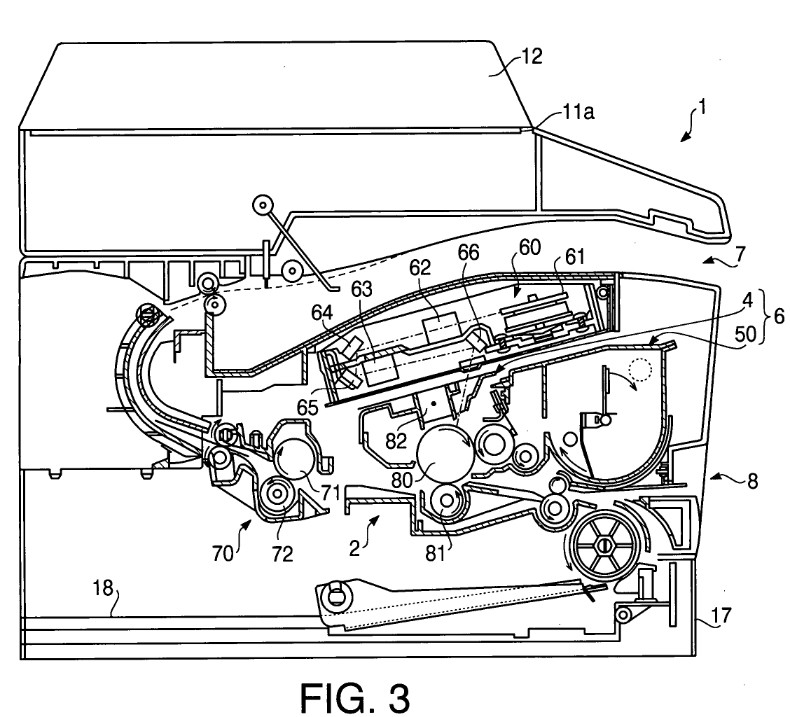

FIG. 1 is a perspective view of a data processing device according to an embodiment. Since the data processing device has a plurality of functions, the data processing device is referred to as an MFP (Multifunction Peripheral) 1 hereinafter. FIG. 2 is a perspective view of the MFP 1 illustrating a state where a body cover 12 is opened with respect to a main body 10. In this embodiment, the MFP 1 has a print function, facsimile function, a scanner function, a copying function and a mailing function (i.e., a function of transmitting or receiving e-mails). The MFP 1 has a sheet tray 17 for supplying sheets of paper 18 (see FIG. 3), the main body 10 in which an image is formed on the supplied sheet 18, the body cover 12 attached to the main body 10 to be openable and closable with respect to the main body 10.

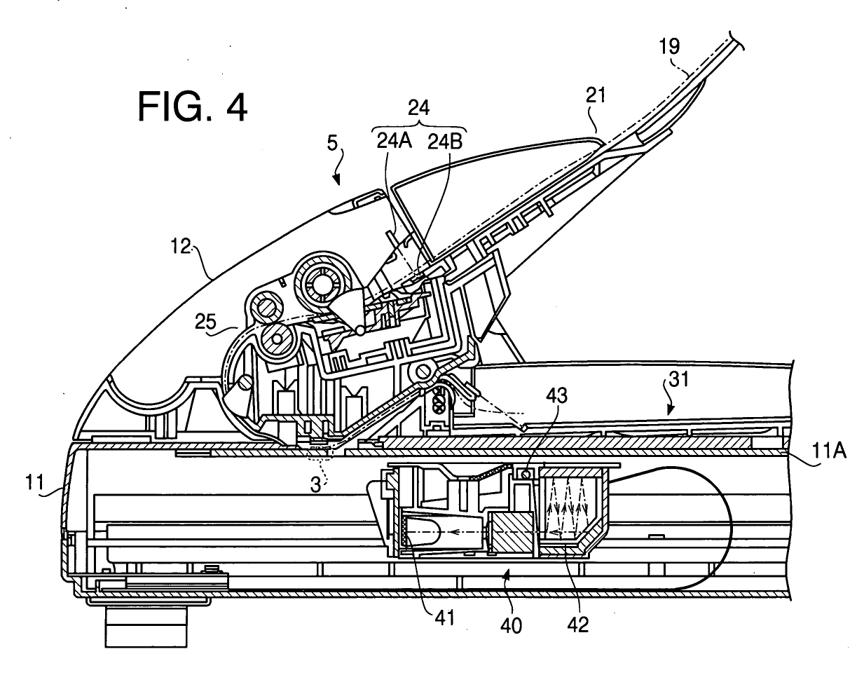

The main body 10 includes a reading unit 40 (see FIG. 4) which reads an image from an original 19 (i.e., information formed on the original 19), an image formation unit 2 which forms an image on the sheet 18, and an operation unit 14 used by a user to input data to the MFP 1. The reading unit 40 and the image formation unit 2 are accommodated in a body case 11.

The body case 11 includes a reading surface 11A (see FIG. 3) on which an original 19 from which information is to be read by the reading unit 40 is placed, a manual feed unit 8 used to feed a sheet 18 to the image formation unit 2 without requiring feeding operation by the sheet tray 17, and a sheet output section 7 to which the sheet 18 on which an image is formed by the image formation unit 2 is ejected. The reading surface 11A is made of transparent material such as glass, and is fixed on the top surface of the body case 11 to face the body cover 12.

The operation unit 14 includes a mode selection key 14A used to select a desired function from among the plurality of functions that the MFP 1 has, a start key 14B used to execute the function selected by the user, a display unit 15 on which various types of information including a status of the MFP 1 are displayed, a menu key 14C used to display a menu on the display unit 15, a cross key 14D used to operate the menu, and a cancel key 14E used to cancel functions.

More specifically, the mode selection key 14A includes a “Copy” key to select the copying function, a “Facsimile” key to select the facsimile function, a “Scanner” key to select the scanner function. Is should be noted that in this embodiment the facsimile function includes a facsimile transmission function of transmitting data and a facsimile receiving function of receiving facsimile data. When the user selects a desired function by operating the mode selection key 14A, the MFP 1 changes onscreen representation and allocation of functions to keys of the operation unit 14 so that operation environments provided through the operation unit 14 are switched depending on the function selected by the user.

When the menu key 14C is operated, a menu having a hierarchical structure of items is displayed on the display 15. In the state where the menu is displayed, layers of the menu are switched by operating left and right buttons of the cross key 14D, selection of the items can be attained by operating upper and lower buttons of the cross key 14D, and setting of the selected item can be attained by operating a central button of the cross key 14D.

Hereafter, the image formation unit 2 is explained in detail with reference to FIG. 3 which illustrates the internal structure of the main body 10 of the MFP 1. The main body 10 includes a laser scanning unit 60 which emits a scanning laser beam to form an image, a process cartridge 6 in which the image formed by the laser scanning unit 60 is transferred to the sheet 18, and a fixing unit 70 which fixes the image transferred to the sheet 18.

More specifically, the laser scanning unit 60 includes a laser diode which emits a laser beam, a polygonal mirror 61 which rotates to reflect the laser beam emitted by the laser diode to form a scanning laser beam, and an optical unit (e.g., lenses 62 and 63 and mirrors 64, 65 and 66) which converges the laser beam. That is, in the laser scanning unit 60, the laser beam emitted by the laser diode is deflected by the polygonal mirror 61 and is converged by the optical unit to change an optical path. Then, the laser beam scans on a photosensitive drum 80 at a high speed.

The process cartridge 6 is configured to perform an imaging process (including a charging process, a developing process, and a transferring process). The process cartridge 6 includes a drum cartridge 4, and a development cartridge 50 accommodating toner (not shown). The development cartridge 50 is detachably attached to the drum cartridge 4.

The drum cartridge 4 is a target to be illuminated by the scanning laser beam. More specifically, the drum cartridge 4 includes the photosensitive drum 80 on which a toner image is formed, an electrification unit 82 which charges the photo sensitive drum 80, and a transferring roller 81 which transfers the toner image on the photosensitive drum 80 to the sheet 18. That is, the toner image on the photosensitive drum 80 is transferred to the sheet 18 when the sheet 18 is carried between the photosensitive drum 80 and the transferring roller 81.

The fixing unit 70 includes a heat roller 71 and a pressing roller 72. The toner image transferred to the sheet 18 is fixed on the sheet 18 by heat and pressure applied by the heat roller 71 and the pressing roller 72 when the sheet 18 passes between the heat roller 71 and the pressing roller 72.

That is, in the image formation unit 2, a latent image formed on the photosensitive drum 80 is developed by supplying toner from the development cartridge 50. When the sheet 18 passes the process cartridge, the toner image is transferred to the sheet 18 which is supplied from the sheet tray 17. Then, the toner image is fixed by the fixing unit 70.

FIG. 4 is a cross sectional view illustrating an internal structure of the body cover 12 and the reading unit 40. As shown in FIG. 4, the body cover 12 includes a placement unit 21 on which an original 19 whose image has not been read by the reading unit 40 yet, a collection unit 31 on which originals 19 whose information have been read by the reading unit 40 are collected, a carrying unit 25 which carries the original from the placement unit 21 to the collection unit 31 via the reading surface 11A. In this case, the reading unit 4 is retained at a reading position 3 for automatic feeding to read the original 19. In the following, frequently, the placement unit 21, the collection unit 31 and the carrying unit 25 are generically called an original automatic feed unit 5.

As shown in FIG. 4, the reading unit 40 includes a light source 43 which emits light to the original 19, an optical element group 42 having a mirror and a lens to collect light reflected from the original 19, and an image sensor 41 which receives the reflected light to read information from the original 19. That is, in the reading unit 40, the light source illuminates the original 19, light reflected from the original 19 is collected by the optical element group 42, and the collected light is received by the image sensor 41 so that information can be read from the original 19.

Further, the reading unit 40 is able to read the original at the reading position 3 for automatic feeding, and is moved by a driving mechanism (not shown) along the reading surface 11A extending in the longitudinal direction of the bode case 11 (i.e., in the right and left direction on FIG. 4).

To read the original 19 through the original automatic feed unit 5, the reading unit 40 is kept at the reading position 3, and then the reading unit 40 reads all information of the original 19 while the original 19 is carried by the original automatic feed unit 5. To use the MFP 1 as a flat bed type scanner (i.e., to read information from the original 19 placed on the reading surface 11A to cover the reading surface 11A), the reading unit 40 reads all information from the original 19 placed on the reading surface 11A while being moved along the reading surface 11A by the driving mechanism.

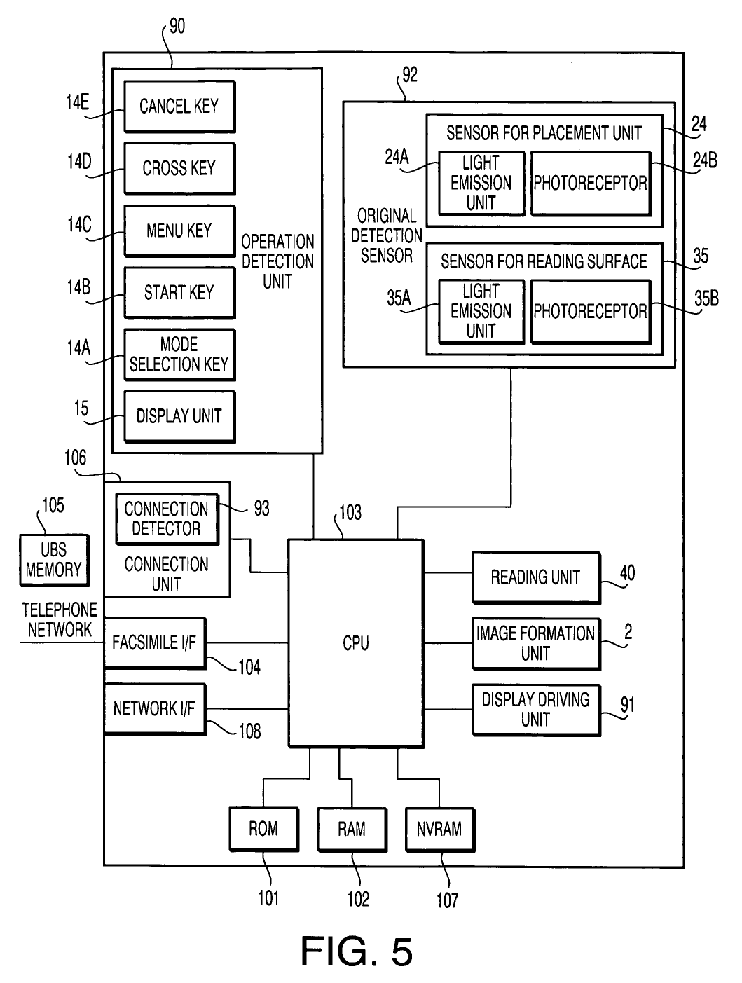

In the placement unit 21, a sensor 24 which detects whether the original 19 is placed on the placement unit 21 is located. In the body case 11, a sensor 35 (see FIG. 5) which detects whether the original 19 is placed on the reading surface 11A is located. Hereafter, frequently, the sensors 24 and 35 are generically called an original detection sensor 92.

The sensor 24 for the placement unit is a photo-sensor and includes a light emission unit 24A and a photoreceptor 24B. The sensor 35 for the reading surface is a photo-sensor and includes a light emission unit 35 and a photoreceptor 35B. The light emission unit 24A and the photoreceptor 24B are placed to face with each other in the placement unit 21 so that light emitted by the light emission unit 24A is blocked by the original 19 placed on the placement unit 21. The light emission unit 35A and the photoreceptor 35B are placed to face with each other so that light emitted by the light emission unit 35A is blocked by the original 19 placed on the reading surface 11A.

In the bode case 11, the photoreceptor 35B is located at a position away from a moving path along which the reading unit 40 moves, while the light emission unit 35A is located in the body cover 12. That is, the sensor 35 is configured such that the photoreceptor 35B receives light from the light emission unit 35A in the state where the body cover 12 is closed.

Therefore, when the original 19 is not placed at a placement position (on the placement unit 21 or on the reading surface 11A), light emitted by the light emission unit (24A or 35A) is detected by the photoreceptor (24B or 25B). Therefore, in this case, a reception signal having a relatively large amplitude is output by the photoreceptor (24B or 35B).

On the other hand, when the original is placed at the placement position, light from the light emission unit (24A or 35A) is blocked by the original 19, and therefore the photoreceptor (24B or 35B) does not detect light. In this case, the photoreceptor (24B or 35B) outputs a reception signal having a small amplitude.

FIG. 5 is a block diagram of a control system of the MFP 1. The MFP 1 includes a network interface 108 which interfaces the MFP 1 with an external device (e.g., a personal computer) and a network (e.g., the Internet), a facsimile interface 104 which interfaces the MFP 1 with a telephone network, and a connection unit 106 to which a portable storage medium such as a USB memory 105 can be detachably attached. The connection unit 106 also serves to read information from a portable storage medium.

The MFP 1 further includes a ROM 101 in which various programs for controlling operations of the MFP 1 are stored, a RAM 102 used as a work memory to temporarily store data, an NVRAM (Non-Volatile RAM) 107 in which data to be kept in a power off state of the MFP 1 is stored, and a CPU 103 which executes various programs stored in the ROM 101.

To the CPU 103, the reading unit 40, the image formation unit 2, a display driving unit 91 serving to display images on the display unit 15, an operation detection unit 90 which detects operations conducted on the operation unit 14, and the original detection sensor 92 are connected. The connection unit 106 has a connection detector 93 which detects connection of the USB memory 105 to the connection unit 106. In this configuration, the connection unit 106 supplies power to the USB memory 105 when the USB memory 105 is attached thereto.

In the USB memory 105, various types files including general image files (e.g., a JPEG file and a TIFF file), PDF files, document files generated by general word processing software, and files of print data (e.g., a PRN file) generated by printer drivers can be stored.

Hereafter, an operation regarding processing of data stored in the USB memory 105 is explained. As described in detail below, the MFP 1 is able to execute the facsimile transmission function, the print function, and E-mail transmission function for data stored in the USB memory 105 in response to connection of the USB memory 105 to the connection unit 106.

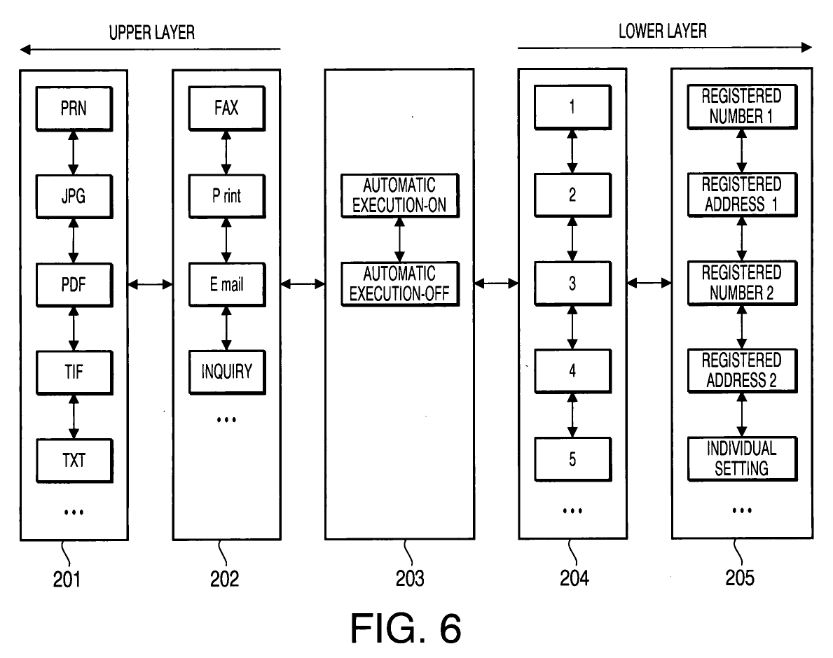

FIG. 6 is an explanatory illustration for explaining a hierarchical menu structure of items used to set automatic execution of the functions of the MFP 1. When the menu key 14C is operated, a top layer menu 201 including menu items illustrated in the left most part of FIG. 6 is displayed on the display unit 15. Through the top layer menu 201, the user is able to select a file format (i.e., data type) for which automatic execution of a function is permitted. In an example of FIG. 6, file formats having extensions of PRN, JPG, PDF, TIF and TXT are set selectable in the top layer menu 201.

Through a next lower layer menu 202 (hereafter, referred to as a second layer 202), the function to be executed in association with the selected file format (i.e., the selected extension) can be selected from among the plurality of functions including the facsimile transmission function, the print function and the E-mail transmission function. The menu of the second layer 202 has an item “inquiry” to inquire the user about the function which the user wants to execute.

Through a next lower layer menu 203 (hereafter, referred to as a third layer 203), the user is allowed to select an item of “automatic execution—ON” for executing a function automatically and an item of “automatic execution—OFF” for executing a function after checking confirmation of execution of the function by the user.

Through a next lower layer menu 204 (hereafter, referred to as a fourth layer 204), the user is able to define priority for processing a plurality of types of file formats. It is understood that such priority is useful if a plurality of types of files are stored in the USB memory 105.

Through a next lower layer menu 205 (hereafter, referred to as a fifth layer 205), the user is allowed to designate destination address information. More specifically, the user is able to select a registered number (e.g., “registered number 1” or “registered number 2”) as a destination for the facsimile transmission and to select a registered address (e.g., “registered address 1” and “registered address 2”) as a destination for the e-mail transmission. Further, in this menu, the user is allowed to select an item “individual setting” for individually designate a destination when data is transmitted.

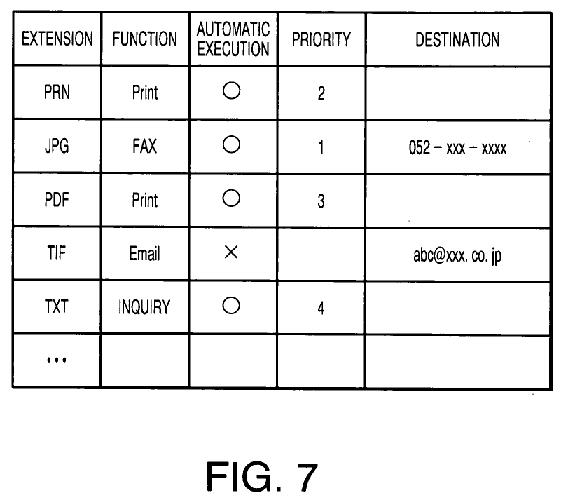

By completing the setting for the hierarchical menu through the cross key 14D, a function management table is formed in the NVRAM 107. That is, a relationship between each file format and a function to be executed is stored in the MFP 1. FIG. 7 illustrates an example of the function management table. In the example shown in FIG. 7, the priority for processing a plurality of types of file formats are defined such that a JPG file, a PRN file, a PDF file, a TXT file are processed in this order if such a plurality of types of files are stored in the USB memory 105.

Regarding a JPG file, the facsimile transmission function is executed automatically to transmit data of the JPG file to a facsimile number “052-xxx-xxxx”. Regarding a PRN file and a PDF file, the print function is executed automatically. Regarding a TXT file, the MFP 1 inquires the user about the function which the user wants to execute. Regarding a TIF file, the E-mail transmission to a destination “abc@xxx.co.jp” is executed after obtaining confirmation of e-mail transmission by the user.

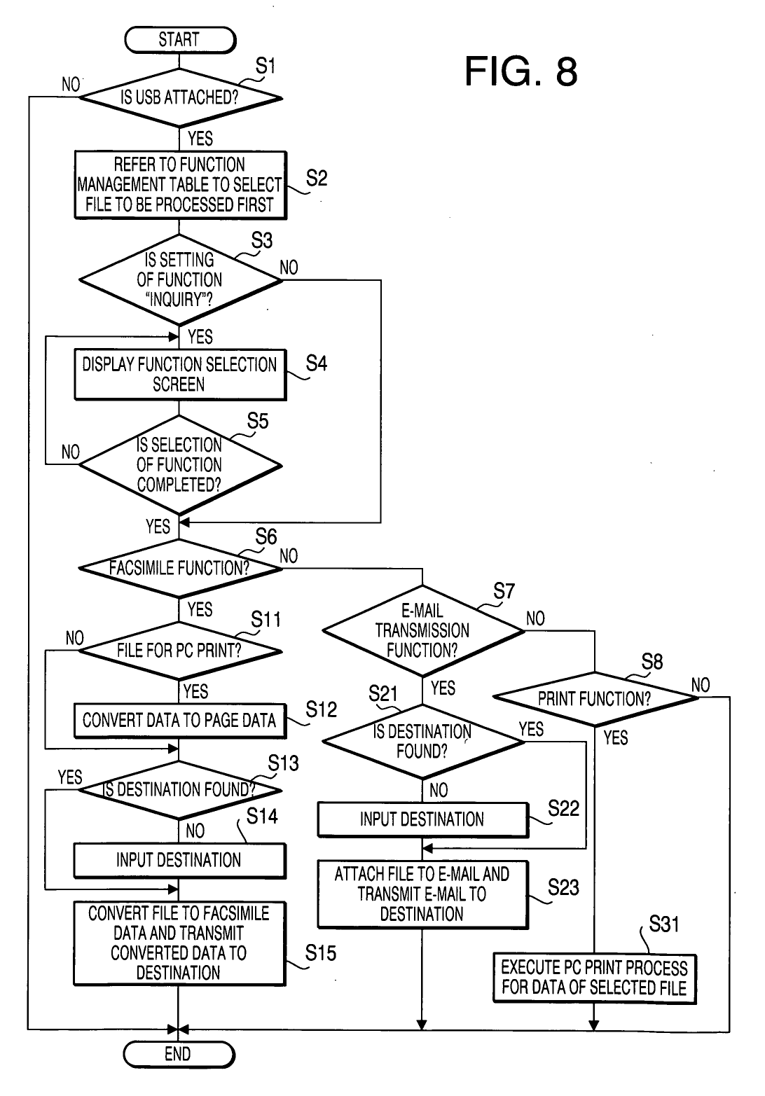

FIG. 8 is a flowchart illustrating a process for automatically executing a function for a file in a USB memory (hereafter, referred to as an automatic function execution process) executed under control of the CPU 103 of the MFP 1. The CPU 103 executes the automatic function execution process periodically at constant time intervals.

First, the CPU 103 judges whether the USB memory 105 is attached to the connection unit 106 through the connection detector 93 (step S1). If the USB memory 105 is not attached to the connection unit 106 (S1: NO), the automatic function execution process terminates. If the USB memory 105 is attached to the connection unit 106 (S1: YES), control proceeds to step S2.

In step S2, the CPU 103 refers to extensions of files in the USB memory 105 and the function management table to select a file to be processed firstly. More specifically, the CPU 103 judges the file type to be processed first in accordance with the priority setting defined in the function management table, and selects a file corresponding to the file type having the highest priority from among unprocessed files in the USB memory 105. In this case, the CPU 103 saves the file name of the file selected in step S2 so that a processed file is not selected again in a later stage.

Next, in step S3, the CPU 103 refers to the function management table to judge whether the function to be executed for the selected file is defined as the item “inquiry”. If the function is defined as the item “inquiry” (step S3: YES), the CPU 103 displays a function selection screen on the display unit 15 (step S4). Then, the CPU 103 judges whether selection of the function through the cross key 14D has been completed (step S5). The CPU 103 waits until selection of the function is completed (S5: NO, and S4).

If selection of the function is completed (S5: YES), the CPU 103 refers to the function management table to judge whether the selected function is the facsimile transmission function (step S6). If it is judged in step S3 that the function to be executed is not defined as the item “inquiry” (S3: NO), control proceeds from step S3 to step S6.

If the function to be executed (i.e., the function defined in the function management table or the function selected through the function selection screen) is not the facsimile transmission function (S6: NO), control proceeds to step S7 where the CPU 103 judges whether the function to be executed is the e-mail transmission function. If the function to be executed is not the e-mail transmission function (S7: NO), control proceeds to step S8 where the CPU 10 judges whether the function to be executed is the print function. If the function to be executed is not the print function (S8: NO), the CPU 103 terminates automatic function execution process without executing any operation for the function. It should be understood that, in a next execution of the automatic function execution process, a file having the second highest priority is selected from among unprocessed files in the USB memory 105 in step S2.

The automatic function execution process may be configured such that, if the function to be executed is not the facsimile transmission function, the e-mail transmission function, and the print function (S8: NO), control returns to step S4 to request the user to select a function to be executed.

If it is judged in step S6 that the function to be executed is the facsimile transmission function (S6: YES), control proceeds to step S11 where the CPU 103 judges whether data of the selected file corresponds to a file for a PC print process (hereafter, referred to as a PC print file) formed of code data. If the selected file is a PC print file (S11: YES), the data of the selected file is converted into page data in step S12, and then control proceeds to step S13. If the selected file is not a PC print file, control proceeds to step S13 without processing step S12. The term “PC print process” as used herein means a process where a file is converted into page data and the converted page data is sent to the image formation unit 2 to print the page data. The term “page data” as used herein means data to be used to form an image, for example, on a sheet of paper, through the image formation unit 2. The term “file for a PC print process” as used herein means a file which needs to be subjected to data conversion to generate page data.

In step S13, the CPU 103 refers to the function management table to judge whether a destination number is defined in the function management table. If a destination number is not defined in the function management table (S13: NO), the CPU 103 displays an address input screen requesting the user to input a destination number on the display unit 15. After a destination number is inputted by the user through the address input screen, control proceeds to step S15. If a destination number is defined in the function management table (S13: YES), control proceeds to step S15.

In step S15, the selected file or the page data generated in step S12 is converted into facsimile data (i.e., data having a facsimile format), and the converted facsimile data is transmitted to the destination number via the telephone network. Then, the automatic function execution process terminates.

More specifically, in step S15, if the setting regarding automatic execution for the selected file is “automatic execution—ON”, the facsimile transmission of data is executed automatically. On the other hand, if the setting regarding automatic execution for the selected file is “automatic execution—OFF”, the CPU 103 inquires the user about whether to execute the facsimile transmission. In this case, the facsimile transmission is executed after the user inputs an OK command. If the CPU 103 inquires the user about whether to execute the facsimile transmission in step S15, the user is allowed to change the destination number.

If the function to be executed is the e-mail transmission function (S7: YES), control proceeds to step S21 where the CPU 103 refers to the function management table to judge whether a destination address for the selected file is defined in the function management table. If a destination address is not defined in the function management table (S21: NO), control proceeds to step S22 where the CPU 103 allows the user to input a destination address as in the case of step S14. After a destination address is inputted by the user, control proceeds to step S23. If a destination address for the selected file is not defined in the function management table (S21: YES), control proceeds to step S23.

Similarly to step S15, in step S23, if the setting regarding automatic execution for the selected file is “automatic execution—ON”, the e-mail transmission is executed automatically. On the other hand, if the setting regarding automatic execution for the selected files is “automatic execution—OFF”, the CPU 103 inquires the user about whether to execute the e-mail transmission. In this case, the e-mail transmission is executed after the user inputs an OK command. If the CPU 103 inquires the user about whether to execute the e-mail transmission in step S23, the user is allowed to change the destination address.

If the function to be executed is the print function (S8: YES), control proceeds to step S31 where the CPU 103 executes a PC print process for data of the selected file. Then, the automatic function execution process terminates. Similarly to steps S15 and S23, if the setting regarding automatic execution for the selected file is “automatic execution—ON”, the PC print is executed automatically. On the other hand, if the setting regarding automatic execution for the selected file is “automatic execution—OFF”, the CPU 103 inquires the user about whether to execute the PC print process. In this case, the PC print process is executed after the user inputs an OK command. If the CPU 103 inquires the user about whether to execute the PC print process in step S31, the user is allowed to cancel the PC print process.

As described, according to the embodiment, it is possible to automatically execute a function in accordance with an extension of a file stored in the USB memory 105 without depending on a file name of the file (i.e., a file name not including an extension). That is, according to the embodiment, it is possible to execute a function in accordance with a data type of a file to be processed. Further, the user is allowed to define the relationship between an extension and the function to be executed.

Therefore, if the user defines destination information for the facsimile transmission function or the e-mail transmission function in the file management table, it is possible to automatically transmit the data to a destination represented by the destination information. Since, regarding the facsimile transmission function, data such as a PC print file which can not be used for facsimile transmission is automatically converted to page data (see S12), the user is able to set the relationship (i.e., the items of the function management table) freely. Therefore, according to the embodiment, even if data is stored in the USB memory 105 on a device (e.g., a personal computer) under a file name assigned freely on the device, it is possible to automatically execute a desired function for the file stored in the USB memory 105.

In the above mentioned embodiment, the user is able to define the function management table such that the MFP 1 inquires the user about the function to be executed each time the MFP 1 executes a function for a file stored in the USB memory 105 (see S3 to S5 of FIG. 8). The user is also allowed to define the function management table such that the MFP 1 inquires the user about a destination address each time the MFP 1 executes a function for a file stored in the USB memory 105 (see S13, S14, S21, S22 of FIG. 8). That is, according to the embodiment, it is possible to appropriately process a file whose function or a destination can not be determined in advance.

Further, regarding the function for which the setting regarding automatic execution is set to “automatic execution—OFF”, the function is not executed until an execution command is inputted by the user. Therefore, it is possible to prevent a process not desired by the user from being automatically executed on the MFP 1.

As described above, the user is allowed to define priority for executing functions. Therefore, if the USB memory 105 has data having high urgency, the MFP 1 is able to process such data preferentially.

The process shown in FIG. 8 can be suspended by operating the cancel key 14E. Therefore, if the cancel key 14E is operated immediately after the USB memory 105 is attached to the connection unit 16, the user is allowed to execute a desired function for a desired file of files in the USB memory 105.

Although the present invention has been described in considerable detail with reference to certain preferred embodiments thereof, other embodiments are possible.

For example, the MFP 1 may have a transfer function of transmitting data to a personal computer. In this case, the transfer function is added to the function management table as one of the functions that the MFP 1 has.

In the above mentioned embodiment, the data type is judged depending on extensions of files. However, the data format may be judged based on various types of information in a file. For example, the data format can be judged based on a property of a file.

The function management table may be formed such that an item of a function corresponding to a file to be processed is set to “inquiry” as default setting. In this case, the automatic function execution process may be configured such that the function selection menu is firstly displayed after the USB memory 105 is connected to the MFP 1 so as to allow the user to select a desired function.

In the above mentioned embodiment, a USB memory is used as a portable storage medium. However, various types of storage media, such as a memory card, can be used as a portable storage medium.

What is claimed is:

1. A data processing device having a plurality of functions including at least a print function of forming an image on a recording medium and a facsimile function of transmitting facsimile data, comprising:
a connection unit to which a portable storage medium is detachably attached;
a storage unit configured to store relationship information defining relationship between a data type and a function to be executed for data having the data type;
a reading unit configured to read data from the portable storage medium attached to the connection unit;
a judgment unit configured to judge a data type of the data read by the reading unit from the portable storage medium; and
a function execution unit configured to execute one of the plurality of functions corresponding to the data type judged by the judgment unit.

2. The data processing device according to claim 1, wherein the plurality of functions further includes an e-mail transmission function of transmitting an e-mail while attaching data read from the portable storage medium to the e-mail.

3. The data processing device according to claim 1, further comprising a setting unit configured to accept a user operation and to set the relationship information stored in the storage unit.

4. The data processing device according to claim 1, wherein, if the data type judged by the judgment unit does not have a corresponding function in the relationship information, the function execution unit does not execute any of the plurality of functions.

5. The data processing device according to claim 1, further comprising a priority setting unit which defines priority for processing a plurality of data types,
wherein if the portable storage medium stores a plurality of data types of files, the function execution unit executes functions respectively corresponding to the plurality of data types of files in accordance with the priority defined by the priority setting unit.

6. The data processing device according to claim 1, further comprising an inquiry unit configured such that if the data type judged by the judgment unit does not have a corresponding function in the relationship information, the inquiry unit inquires a user about a function to be executed.

7. The data processing device according to claim 1, further comprising a cancellation unit configured to disable the function execution unit and to allow a user to select a function to be executed for the data read by the reading unit from among the plurality of functions.

8. The data processing device according to claim 1, wherein the function execution unit is configured not to execute one of the plurality of functions corresponding to the data type judged by the judgment unit until an execution command is received.

9. The data processing device according to claim 1, wherein:
in the relationship information, a destination is defined in association with a predetermined function; and
if the data type of the data in the portable storage medium corresponds to the predetermined function, the function execution unit executes the predetermined function such that data read from the portable storage medium is transmitted to the destination defined in the relationship association with the predetermined function.

10. The data processing device according to claim 9, wherein:
if the destination is not defined in the relationship information for the predetermined function, the function execution unit moves to a waiting state in which the predetermined function is not executed until a destination is inputted by a user.

11. The data processing device according to claim 10, wherein in the waiting state the function execution unit requests a user to input a destination for the predetermined function.

12. The data processing device according to claim 9, wherein the predetermined function is one of the facsimile function and an e-mail transmission function.

13. The data processing device according to claim 1, further comprising a data conversion unit configured such that if data having the data type judged by the judgment unit needs data conversion for a corresponding function, the data conversion unit converts a data format of the data so that the data can be processed by the corresponding function.

14. The data processing device according to claim 1, wherein the judgment unit judges the data type of the data read from the portable storage medium without depending on a file name of the data.

15. A method of processing data on a data processing device having a plurality of functions including at least a print function of forming an image on a recording medium and a facsimile function of transmitting facsimile data, the method comprising the steps of:
reading data from a portable storage medium attached to the data processing device;
judging a data type of the data read from the portable storage medium; and
executing one of the plurality of functions corresponding to the data type in accordance with relationship information defining relationship between each data type and a corresponding function to be executed.

16. A method of processing data on a data processing device having a plurality of functions including at least a print function of forming an image on a recording medium and a facsimile function of transmitting facsimile data, the method comprising the steps of:
reading data from a portable storage medium attached to the data processing device in accordance with priority information defining priority for processing a plurality of data types; and
executing one of the plurality of functions corresponding to a data type of the data read from the portable storage medium in accordance with relationship information defining relationship between each data type and a corresponding function to be executed.
